(19) United States
(12) Patent Application Publication
(10) Pub. No.: US 2005/0183297 A1
(43) Pub. Date: Aug. 25, 2005

(54) Light emitting diode display for flower card

(76) Inventor: Kenneth R. Epstein, Burbank, CA (US)

Correspondence Address: William Propp, Esq.;8205 Santa Monica Boulevard, PMB1-245, West Hollywood, CA, 90046, US

(21) Appl. No.: 10/785,127

(22) Filed: Feb. 23, 2004

(51) Int. Cl. G09F 3/16

(52) U.S. Cl. 40/124.02; 40/666

(57) ABSTRACT

A light emitting diode light display is clamped to a card in a flower arrangement. The light emitting diode display contained within a housing consists of a plurality of light emitting diodes, a light emitting diode control circuit, an on/off switch, and at least one battery as a power source, all mounted on a printed circuit board. The front section of the housing has a plurality of apertures through which the light emitting diodes extend to emit light to illuminate the card and the flower arrangement. The back section of the housing has clamping means to removably secure the light emitting diode display to the card.

### BACKGROUND OF THE INVENTION

This invention relates generally to cards in flower arrangements and, more particularly, this invention is directed to a light emitting diode display for the card and the flower arrangement.

Cards are typically placed in flower arrangements with either a pre-printed message on the card or with a hand-written message on the card from the person sending the flower arrangement or both pre-printed and hand-written messages on the card. The card itself is made of folded cardboard or other sheet stock.

In the past, illuminating greeting cards will have a double layer of the sheet stock for the inner layer of the card. An internal light source will be sandwiched between the double layer so that when the card is opened, a light will automatically switch on, as shown in U.S. Pat. Nos. 4,363,081, 4,497,126, and 4,055,014.

However, these illuminating greeting cards require a special card, which is more expensive than a normal greeting card. The illuminating greeting cards have a more limited number of pre-printed greetings and have a more limited variety of cards than a normal greeting card.

It is difficult to hand-write a message on the double layer of the card over the light source. Errors in writing can occur due to the different thicknesses of the layer and the general problems of writing on an uneven, non-flat surface. Punch-throughs and possible damage to the underlying light source are also a concern.

Illuminating greeting cards also tend to be bulky, heavy and expensive to manufacture.

Illuminating greeting cards tend to be larger than flower arrangement cards, which can present problems with positioning the card in bouquets and vases.

It is an object of this invention to provide an illuminating display for a card, separate from the card but attached to the card, for use in flower arrangements.

### BRIEF SUMMARY OF THE INVENTION

According to the present invention, a light emitting diode light display is clamped to a card in a flower arrangement. The light emitting diode display contained within a housing consists of a plurality of light emitting diodes, a light emitting diode control circuit, an on/off switch, and at least one battery as a power source, all mounted on a printed circuit board.

The front section of the housing has a plurality of apertures through which the light emitting diodes extend to emit light to illuminate the card and the flower arrangement. The back section of the housing has clamping means to removably secure the light emitting diode display to the card.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a perspective view of a first embodiment of a light emitting diode display for a card in a flower arrangement of the present invention.

FIG. 2 is a cross-sectional side view of the light emitting diode display of FIG. 1.

FIG. 3 is a cross-sectional front view of the light emitting diode display of FIG. 1.

FIG. 4 is a perspective view of a second embodiment of a light emitting diode display for a card in a flower arrangement of the present invention.

FIG. 5 is a perspective view of a third embodiment of a light emitting diode display for a card in a flower arrangement of the present invention.

### DETAILED DESCRIPTION OF PREFERRED EMBODIMENTS

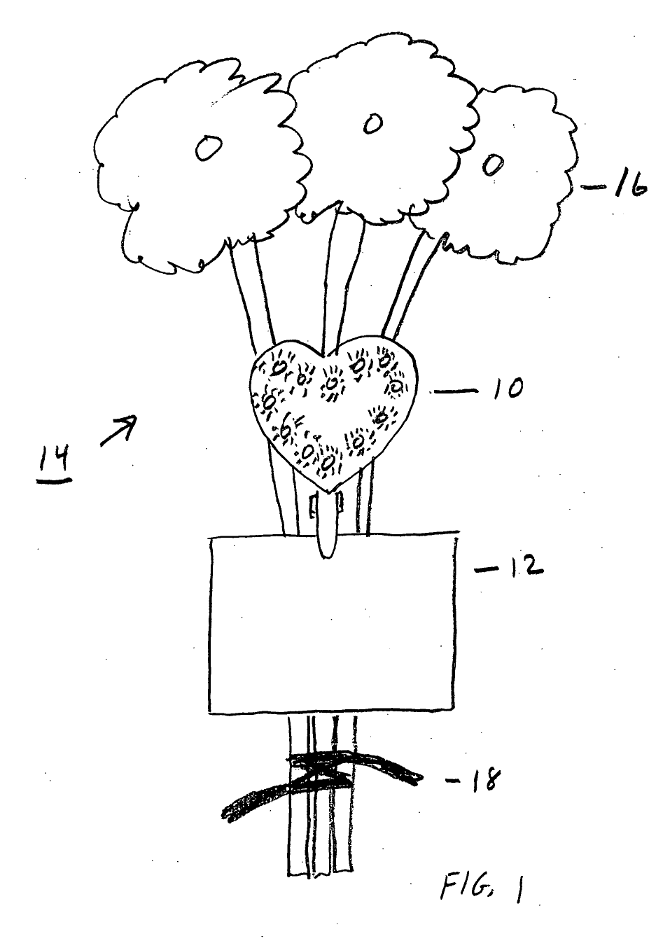

Reference is now made to FIG. 1 illustrating a light emitting diode light display 10 clamped to a card 12 in a flower arrangement 14. In this illustrative example, the flower arrangement is a bouquet of flowers 16 bound by a ribbon 18.

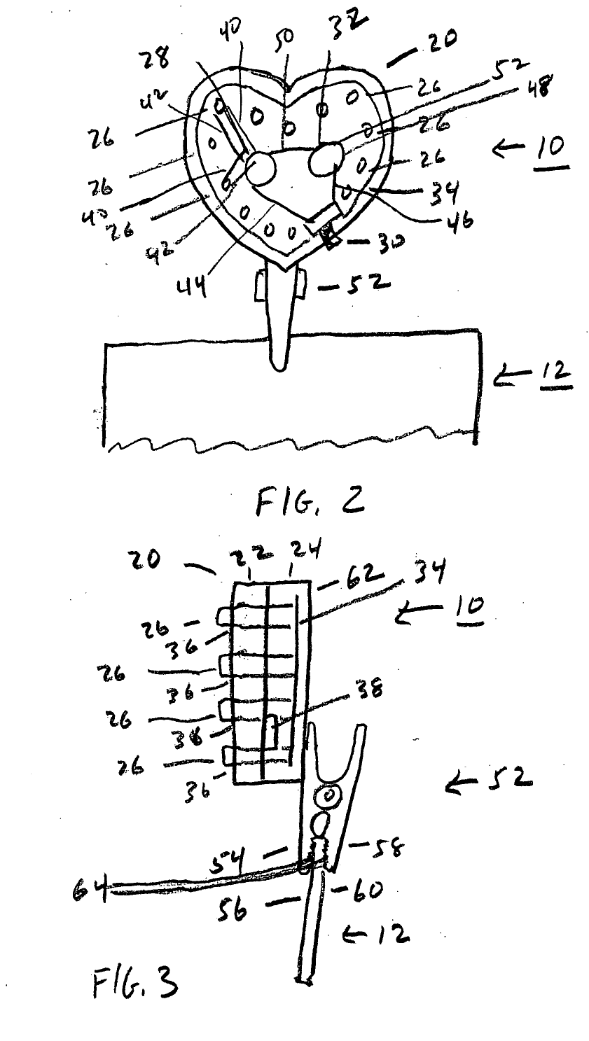

The first embodiment of the light emitting diode display 10 of FIG. 2 and FIG. 3 has a housing 20 formed from a suitable material such as a hard plastic or a hard metal. The housing 20 in this illustrative example is formed in the shape of a heart, although the actual shape of the housing may be any decorative or ornamental design without effecting the present invention. The housing 20 has a front section 22 and a back section 24. The front section 22 and the back section 24 are bonded or secured together to form the housing 20 by adhesive, screws, spot-welds, chemical bonds, heat bonds, snap-togethers or any other conventional fastening means.

The light emitting diode display 10 enclosed within the housing 20 consists of a plurality of light emitting diodes (LED) 26, a light emitting diode control circuit 28, an on/off switch 30, and at least one battery 32 as a power source, all mounted on a printed circuit board 34.

The front section 22 of the housing 20 has a plurality of apertures 36 through which the light emitting diodes 26 extend from within the housing to outside the housing to emit light to illuminate the card and the flower arrangement. The housing has a second aperture 38 in the back section 24 through which the on/off switch 30 extends from within the housing to outside the housing to allow the light emitting display to be turned on and off. The light emitting diode display will have one or more light emitting diodes and the housing will have a corresponding one or more apertures for the light emitting diodes.

The second aperture can alternately be in the front section 22 of the housing.

The light emitting diodes 26, the light emitting diode control circuit 28, the on/off switch 30, and the battery 32 are wired in series or series-parallel. All wiring is done on the printed circuit board 34. The printed circuit board 34 is fastened to the back section 24 of the housing 20 by adhesive, screws, spot-welds or any other conventional fastening means.

The battery 32 is a conventional thin battery such as a watch battery.

The light emitting diodes 26 are connected by first wires 40 and second wires 42 to the light emitting diode control circuit 28. A third wire 44 connects the light emitting diode control circuit 28 to the on/off switch 30. A fourth wire 46 connects the on/off switch 30 to the positive side 48 of the battery 32. A fifth wire 50 connects the negative side 52 of the battery to the light emitting diode control circuit 28. The light emitting diodes 26, the light emitting diode control circuit 28, the on/off switch 30, the battery 32, and the wires form the electrical circuit for the light emitting diode display 10. The external slide switch 30 when moved will activate and deactivate the light emitting diode display 10.

With the switch 30 in the on position, the electrical circuit is completed for the battery 32 to provide power to the LEDs 26 for light emission which is controlled by the circuit 28. The emitted light from the light emitting diodes 26 extending through the apertures 36 in the housing 20 illuminates the card and the flower arrangement.

The light emitting diode light display 10 is removably secured to a card 12 by clamping means 52 of a spring-loaded alligator clip of either plastic or metal material. The first jaw 54 of the alligator clip 52 will grasp the front side 56 of the card 12 and the second jaw 58 of the alligator clip 52 will grasp the back side 60 of the card 12 thus holding the attached light emitting display 10 to the card 12. The jaws 54 and 58 can be moved apart to remove the card from the clamping means 52 and the light emitting diode display 10. The card can be any firm rigid material such as metal, plastic or organic but is typically sheet stock.

The clamping means 52 are fastened to the back 62 of the back section 24 of the housing 20 by adhesive, screws, spot-welds, chemical bonds, heat bonds or any other conventional fastening means.

The first and second jaws 54 and 58 have notches 64 to better grasp the card 12. Alternately, the jaws can have a high friction fabric to secure the card or simple flat surfaces. A spring may not be necessary for the clamping means if the jaws are manufactured with a normal compression between the jaws.

The LED control circuit 28 can be a simple blinker circuit with a specified or variable repetition rate and a specified or variable duty cycle to turn the LED 26 on and off to illuminate the card and flower arrangement. The LED control circuit 28 can also set or vary the intensity of the light emitted by the LED 26 and consequentially set or vary the intensity of the light illuminating the card and flower arrangement. The LED control circuit 28 can provide other more complex light patterns for the LED 26 and the illumination of the card and the flower arrangement flower. The LED control circuit 28 may be integral with the light emitting diodes 26 as a module.

A control circuit is not necessary for the present invention. The switch 30 provides a simple on/off pattern for the light emitting diode display 10 to illuminate the card and the flower arrangement. Without a control circuit, the light emitting diodes would be connected electrically and physically to the on/off switch and the negative side of the battery.

The on/off switch 30 can be momentary, push button, pressure sensitive, rotating, rotating momentary, variable resistance switches consisting of rotating, pressure sensitive, or momentary rotating.

The light emitting diode display is shown as clamping to the top of the card. Alternately, the light emitting display can clamp to the right or left side of the card or the bottom of the card. Also alternately, the card can have a front outer section and a rear inner section hinged together about a fold with the light emitting diode display clamping to any of the four sides of the front or rear sections of the card.

The flower arrangement of the present invention need not be a bouquet. It can be flowers in a vase or some other flower display.

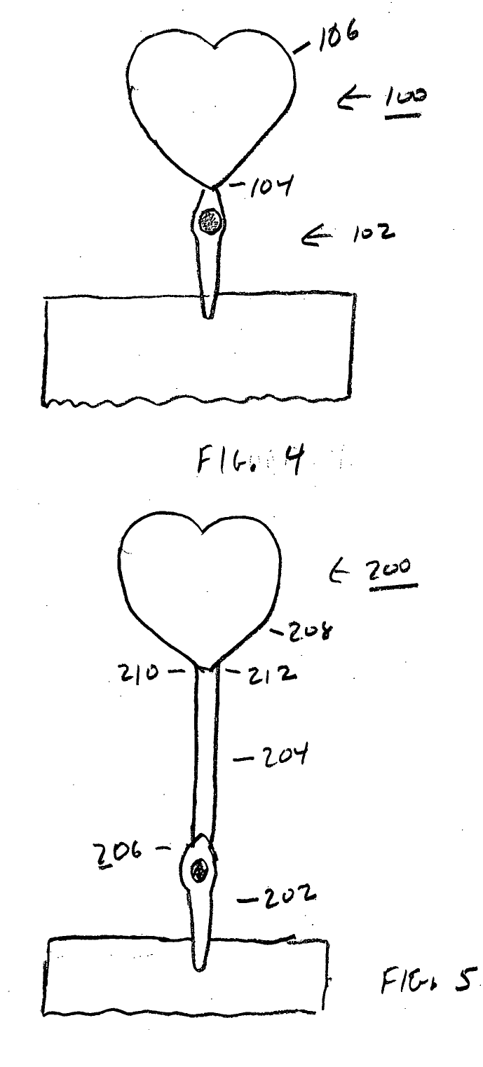

A second embodiment of the light emitting diode display 100 has the clamping means 102 fastened to the bottom 104 of the housing 106 as shown in FIG. 4. The second embodiment of the light emitting diode display 100 of FIG. 4 is otherwise the same as the first embodiment of the light emitting diode display 10 of FIG. 2 and FIG. 3.

A third embodiment of the light emitting diode display 200 has the clamping means 202 fastened to a shaft 204 at a first end 206 with the housing 208 fastened to the shaft 204 at the second end 210 as shown in FIG. 5. The first end 206 and the second end 210 are at opposite ends of the shaft 204. The shaft can be formed from a suitable material such as a hard plastic or a hard metal and need not be same material as the housing nor the clamping means.

The shaft 204 can be fastened to the bottom 212 of the housing 208 as shown in the Figure or to the back side of the housing (not shown in the Figure).

The third embodiment of the light emitting diode display 200 of FIG. 5 is otherwise the same as the first embodiment of the light emitting diode display 10 of FIG. 2 and FIG. 3.

The light emitting diode display of the present invention is releasably attached to the card in the flower arrangement rather than being in the card sandwiched between sheet layers. The light emitting diode display of the present invention can be attached to any floral card and presents ease of hand-writing messages within the card.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A light display for a card in a flower arrangement comprising
a flower arrangement;
a card of sheet stock in said flower arrangement;
a light display having
a power source;
at least one light emitting diode driven by said power source to emit light;
a switch for closing or opening a circuit to turn said power source on and off;
a housing enclosing said light display, said housing having a front section with at least one aperture, said at least one light emitting diode extending through said at least one aperture to emit light to illuminate said card and said flower arrangement; and
a clamping means attached to said housing to removably secure said light display to said card.

2. The light display for a card in a flower arrangement of claim 1 further comprising
a light emitting diode control circuit in said light display to pattern the emission of light from said at least one light emitting diode to illuminate said card and said flower arrangement.

3. The light display for a card in a flower arrangement of claim 1 wherein said power source is at least one battery.

4. The light display for a card in a flower arrangement of claim 1 wherein said clamping means is attached to a back section of said housing.

5. The light display for a card in a flower arrangement of claim 1 wherein said clamping means is attached to the bottom of said housing.

6. The light display for a card in a flower arrangement of claim 1 further comprising
a shaft having a first end and a second end, said first end being opposite said second end, said clamping means attached to said first end of said shaft and said housing attached to said second end of said shaft.

7. The light display for a card in a flower arrangement of claim 1 wherein said clamping means is an alligator clip.

8. The light display for a card in a flower arrangement of claim 1 further comprising
a circuit board, said light display being mounted on said circuit board, said circuit board being within said housing.

9. A light display for a card in a flower arrangement comprising
a flower arrangement;
a card of sheet stock in said flower arrangement;
a light display having
at least one battery;
at least one light emitting diode driven by said at least one battery to emit light;
a light emitting diode control circuit in said light display to pattern the emission of light from said at least one light emitting diode to illuminate said card and said flower arrangement;
a switch for closing or opening a circuit to turn said at least one battery on and off;
a housing enclosing said light display, said housing having a front section with at least one aperture, said at least one light emitting diode extending through said at least one aperture to emit light to illuminate said card and said flower arrangement; and
a clamping means attached to said housing to removably secure said light display to said card.

10. The light display for a card in a flower arrangement of claim 9 wherein said clamping means is attached to a back section of said housing.

11. The light display for a card in a flower arrangement of claim 9 wherein said clamping means is attached to the bottom of said housing.

12. The light display for a card in a flower arrangement of claim 9 further comprising
a shaft having a first end and a second end, said first end being opposite said second end, said clamping means attached to said first end of said shaft and said housing attached to said second end of said shaft.

13. The light display for a card in a flower arrangement of claim 9 wherein said clamping means is an alligator clip.

14. The light display for a card in a flower arrangement of claim 9 further comprising
a circuit board, said light display being mounted on said circuit board, said circuit board being within said housing.

15. A light display for a card in a flower arrangement comprising
a flower arrangement;
a card of sheet stock in said flower arrangement;
a light display mounted on a circuit board having
at least one battery;
at least one light emitting diode driven by said at least one battery to emit light;
a light emitting diode control circuit in said light display to pattern the emission of light from said at least one light emitting diode to illuminate said card and said flower arrangement;
a switch for closing or opening a circuit to turn said at least one battery on and off;
a housing enclosing said light display, said housing having a front section with at least one aperture, said at least one light emitting diode extending through said at least one aperture to emit light to illuminate said card and said flower arrangement; and
an alligator clip attached to said housing to removably secure said light display to said card.

16. The light display for a card in a flower arrangement of claim 1 wherein said alligator clip is attached to a back section of said housing.

17. The light display for a card in a flower arrangement of claim 1 wherein said alligator clip is attached to the bottom of said housing.

18. The light display for a card in a flower arrangement of claim 1 further comprising
a shaft having a first end and a second end, said first end being opposite said second end, said alligator clip attached to said first end of said shaft and said housing attached to said second end of said shaft.
